(19) United States
(12) Patent Application Publication
(10) Pub. No.: US 2002/0006325 A1
(43) Pub. Date: Jan. 17, 2002

(54) HIGH VISIBILITY ROUGH TERRAIN FORKLIFT WITH TIGHT TURNING RADIUS AND EXTENSIBLE BOOM

(75) Inventors: MARK D. GRANROTH, BARAGA, MI (US); DAVE RAASAKKA, HANCOCK, MI (US); JAMES KANGAS, CALUMET, MI (US)

Correspondence Address: MATTHEW E LANO, MCDERMOTT WILL AND EMERY, 227 WEST MONROE STREET, CHICAGO, IL, 60606

(73) Assignee: Pettibone, LLC

(21) Appl. No.: 09/286,152

(22) Filed: Apr. 5, 1999

(51) Int. Cl. B66C 1/00

(52) U.S. Cl. 414/685

(57) ABSTRACT

A low profile, extensible boom, rough terrain forklift is provided with an engine and drive train centrally mounted within a narrowed frame to provide clearance between the rough terrain forklift wheels and the narrow frame such that the forklift has a tight turning radius without increasing the overall width of the forklift. In addition to the centrally mounted engine, the pivotal mount of the extensible boom is elevated from the frame to allow a forklift operator complete visibility of the terrain surrounding the forklift.

### BACKGROUND OF THE INVENTION

1. Field of the Invention

The present invention relates generally to a forklift; particularly to a rough terrain forklift having a low profile, a tight turning radius with large diameter tires and an extensible boom wherein the forklift is configured to provide an operator with a high degree of terrain visibility.

2. Background of the Invention

Rough terrain forklifts having a variable reach or extensible boom are well known in the construction industry. Extensible boom forklifts typically comprise a frame having a front and rear set of opposing wheels. An extensible boom is usually pivotally connected to the frame at a rearward portion thereof and extends forward over the frame. An operator station is typically mounted at the side of the frame between a set of front and rear wheels and an engine is often placed at the side of the frame opposing the operator station or at the rear of the frame adjacent to the pivotal connection between the boom and the frame. A drive train is typically positioned to direct the power of the engine through a transmission and then to the wheels.

Rough terrain forklifts are typically employed for the transport and placement of loads. Prior to transporting a load, an operator will usually engage the load with a load handling attachment at the end of a forklift boom, lift the load from the surface upon which it rests by elevating the boom and adjust the boom to place it in a transport configuration. The transport configuration will elevate the load a sufficient distance from the ground to ensure that neither the load nor the load handling attachment of the boom inadvertently encounter the ground during transportation. This load elevation will necessarily be greater when the terrain is rough than when the terrain is relatively even. Stability dictates, however, that the load not be positioned too far above the forklift center of gravity. The environment in which the forklift is used may also limit the elevation of the load in the transport configuration. For example, a forklift employed to move a load from a construction site into a building might be required to pass through a doorway. In this instance, it is known that the vertical elevation of the boom, load handling attachment or load can extend no higher than the vertical opening of the doorway.

The extensible feature of a boom is employed to facilitate the handling of a load at a position to which the forklift cannot travel. For example, if delivery of a load is required at a second or higher floor of a building, the forklift cannot accomplish delivery by simply driving to that location. Instead, the forklift must elevate and extend the boom to place the load on the desired floor. Conversely, the forklift may retrieve a load from an elevated position such as a storage rack in a warehouse.

It has been found that operator visibility of the terrain surrounding a forklift is crucial to avoiding injury to personnel working around the forklift and avoid damaging, for example, nearby structures, waterlines or electrical lines. When provided with an unobstructed view of the terrain, an operator may quickly and efficiently operate the forklift with confidence it is being done safely.

As mentioned above, prior forklifts typically placed an engine either to a side of the frame opposing the operator station or rearward of the operator station near the boom pivot point. In either configuration, the engine substantially obstructed the operator's visibility of the surrounding terrain. For example, an engine fixed to the right side of the frame would obstruct the operator's view of the entire area of terrain between the right front wheel and right rear wheel and for a substantial distance outward beyond the forklift. Likewise, rear mounted engines obstructed the rearward view necessary to move the forklift rearward. Because forklifts are often required to operate in a tight area such as a warehouse or inside of a building under construction, it can be crucial that an operator have an unobstructed view of the area immediately surrounding the forklift. Operators of forklifts with rear or side mounted engines were therefore susceptible to inadvertently contacting a building, person or other object around which the forklift was operating.

Prior extensible boom forklifts pivotally connected the boom to the forklift at a position significantly lower than the eye height of an operator thereof. Elevating the free end of the boom, to place the boom into the transport configuration positioned for example, positioned the boom directly in the line of sight between the operator and the opposing side of the forklift. The boom of these forklifts thus obstructed the sight of the operator whenever the forklift was in the transport configuration; the very time at which the operator's sight was most necessary. With the operator's vision thus obstructed, persons or objects subject to harm from movement of the forklift could not be seen by an operator. These forklifts were, therefore, unacceptable for safe operation.

Maneuverability is another major concern of forklifts and constitutes various factors dictated by the forklift configuration. One maneuverability factor is the overall size of the forklift because forklift size may dictate the environment in which the forklift may be used. For example, if the overall height of the forklift is too high to pass under the top of an average doorframe, that forklift will not be able to enter buildings to deliver loads of construction materials. Maneuverability may similarly be limited by the overall width of the forklift. It is therefore important to limit the overall dimensions of the forklift. Turning radius is another factor of maneuverability. For any given distance between a pair of front wheels and a pair of rear wheels on a forklift, the turning radius will be dictated by the largest degree of pivot through which the wheels may be turned. The degree of wheel pivot might, in turn, be dictated by the tire clearance between the tires which comprise the wheels, and the frame. Yet another factor of maneuverability is the level of terrain roughness over which a forklift may travel. The terrain over which the forklift may travel is dictated by, among other factors, the ground clearance provided by the tires between the ground and the bottom of the forklift frame or turn axles, whichever is lower. Thus, a rough terrain forklift requires large diameter wheels and, therefore, tire clearance between the wheels and frame.

Although tire clearance between the wheels and the frame is desirable, it was previously thought that increased tire clearance inherently increased the overall width of the forklift for a given width of a frame. Therefore, it was heretofore thought that a trade off had to exist between the turning radius of a forklift and its overall width and that one factor of maneuverability could not be increased without decreasing the other.

### SUMMARY OF THE INVENTION

It is one of the principal objectives of the present invention to provide a rough terrain forklift with an extensible boom which provides complete terrain visibility to an operator and has a tight turning radius.

It is another objective of the present invention to provide a forklift having large diameter wheels and a high degree of wheel pivot.

It is another objective of the present invention to provide a forklift having a narrow forklift width and large diameter wheels with a high degree of wheel pivot.

It is another objective of the present invention to provide a forklift having a narrow forklift frame and large diameter wheels with a high degree of wheel pivot.

It is another objective of the present invention to provide a forklift having large diameter tires and an engine centrally mounted in a narrow frame facilitating a tight turning radius across rough terrain.

It is another objective of the present invention to provide a forklift having a high pivotally mounted extensible boom and an engine centrally mounted in the forklift frame.

It is still another objective of the present invention to provide a forklift having a low overall profile and providing complete terrain visibility to an operator.

### BRIEF DESCRIPTION OF DRAWINGS

FIG. 1 is a perspective view of a forklift according to the present invention.

FIG. 2 is a side elevational view of the forklift shown in FIG. 1.

FIGS. 3A-3D are side elevational views of the forklift shown in FIG. 1 with the boom in various stages of elevation and extension.

FIG. 4A is a top elevational view of the frame and engine of the forklift shown in FIG. 1.

FIG. 4B is a perspective view of part of the frame and engine of the forklift shown in FIG. 4A.

FIG. 4C is a front elevational view of the frame and engine shown in FIG. 4B.

FIG. 4D is a left side elevational view of the right side frame rail and engine of the forklift shown in FIG. 4A having a drive train and right side wheels.

FIG. 5 a top elevational view of the frame, wheels and turn axles of the forklift in FIG. 1.

### DETAILED DESCRIPTION OF THE DRAWINGS

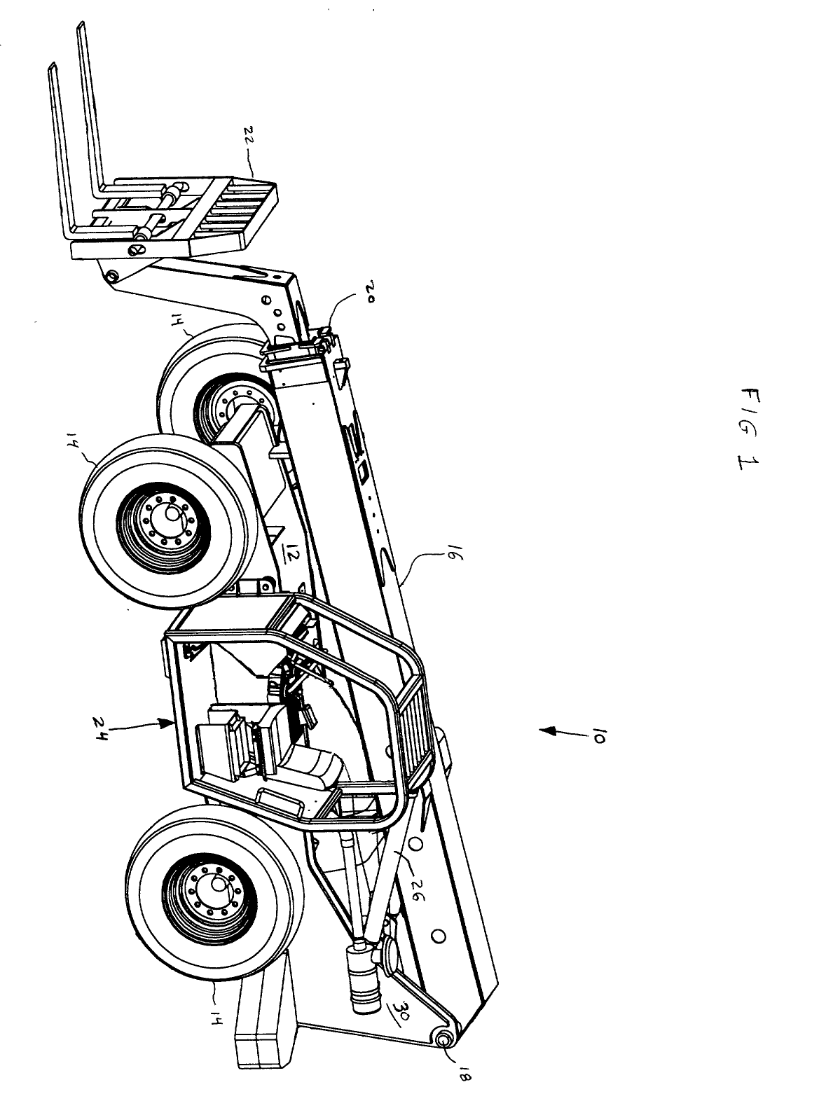

In one embodiment of the present invention depicted in FIG. 1, a forklift 10 comprises a frame 12 supported by four wheels 14, wherein a front wheel and a rear wheel are mounted on each of the left and right side of the frame 12. A telescopically extensible boom 16 is pivotally attached to the frame 12 at a rearward section thereof at pivot point 18 and a free end 20 of the boom 16 lies forward of the pivot point 18 over the frame 12. A load handling attachment 22 is depicted as extending from the extensible boom free end 20. An operator station 24 is shown as extending from the left side of the frame 12 and positioned between the left side front wheel and left side rear wheel of the wheels 14.

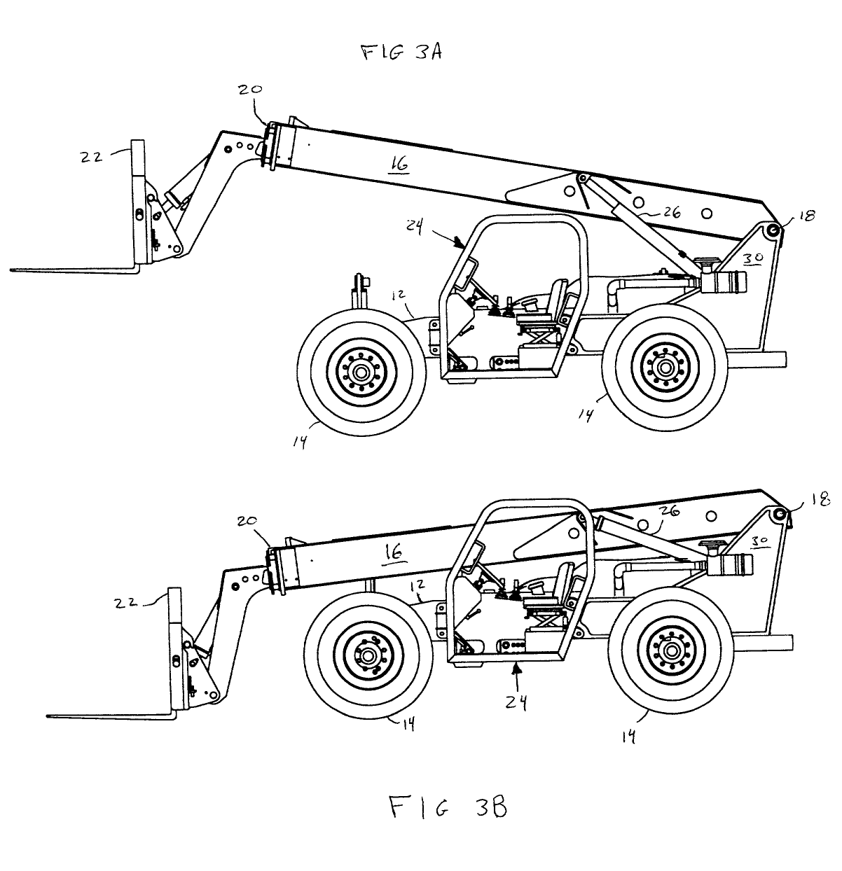

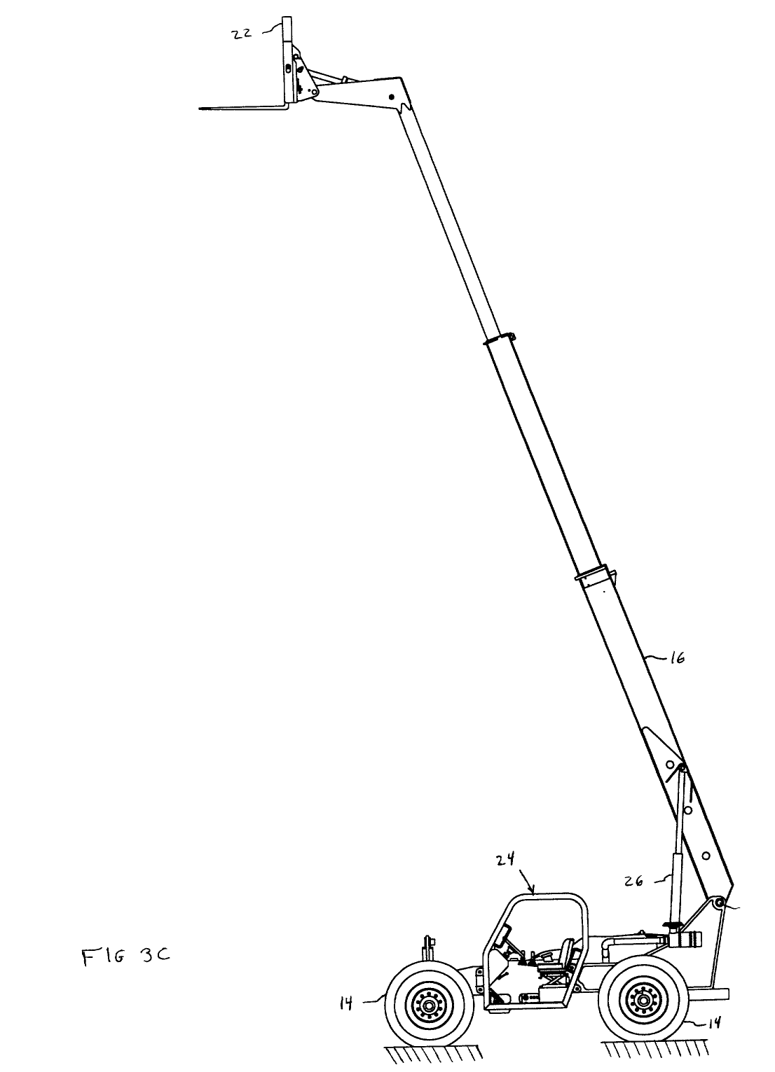

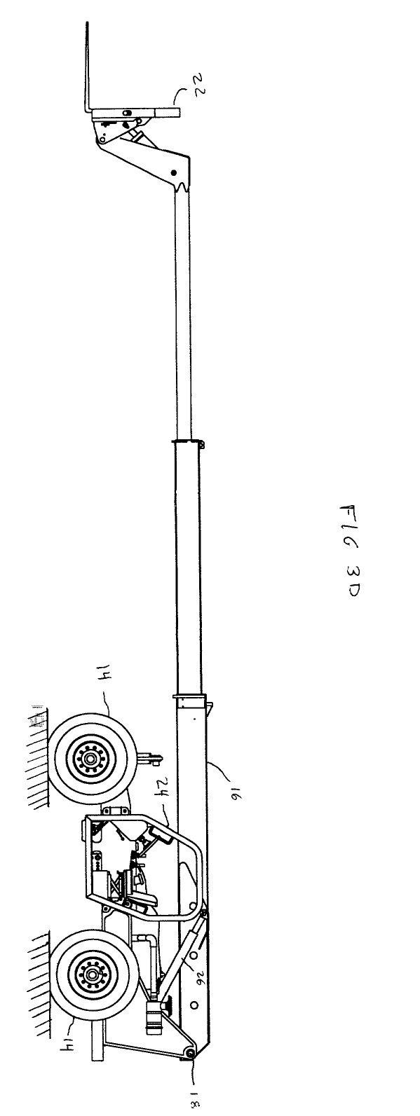

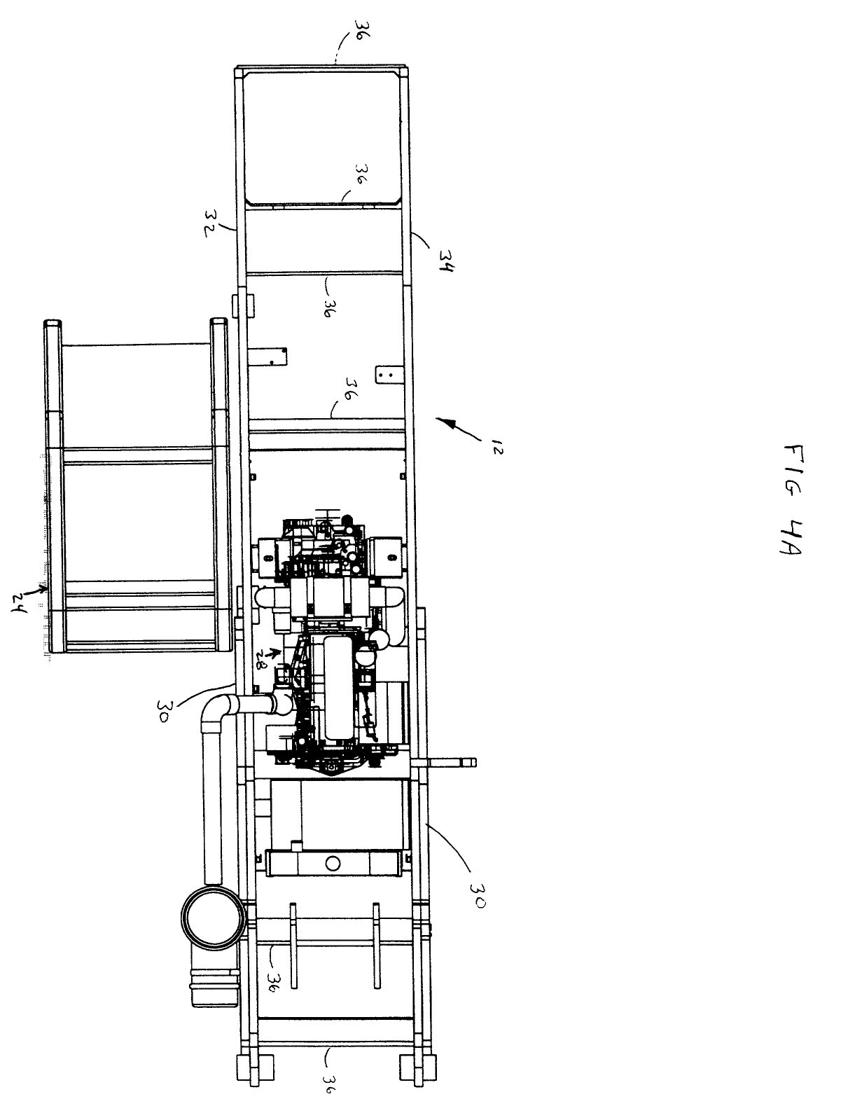

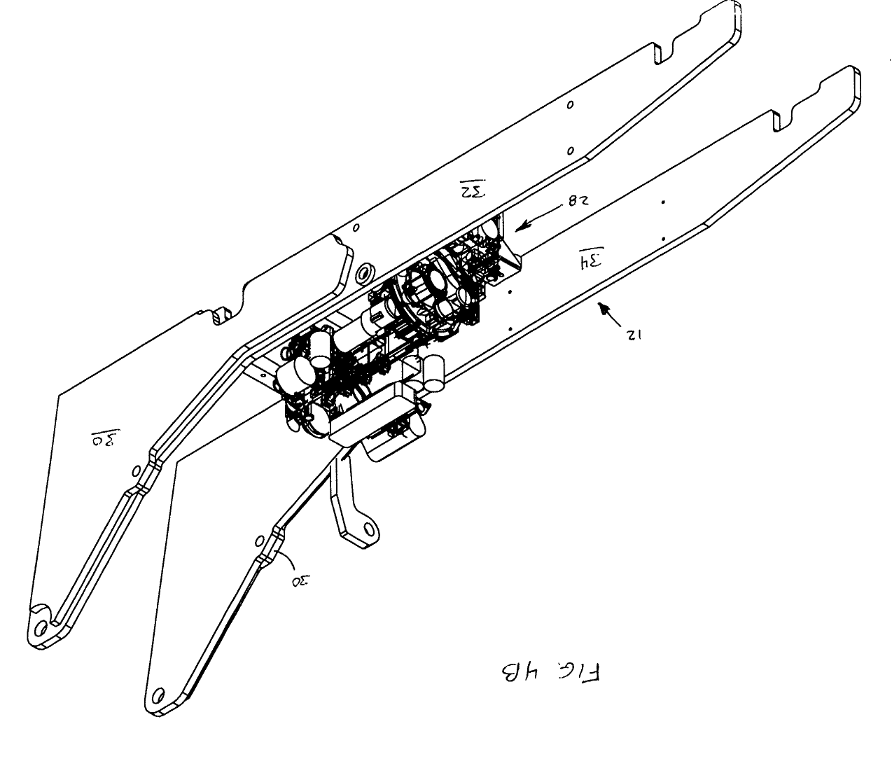

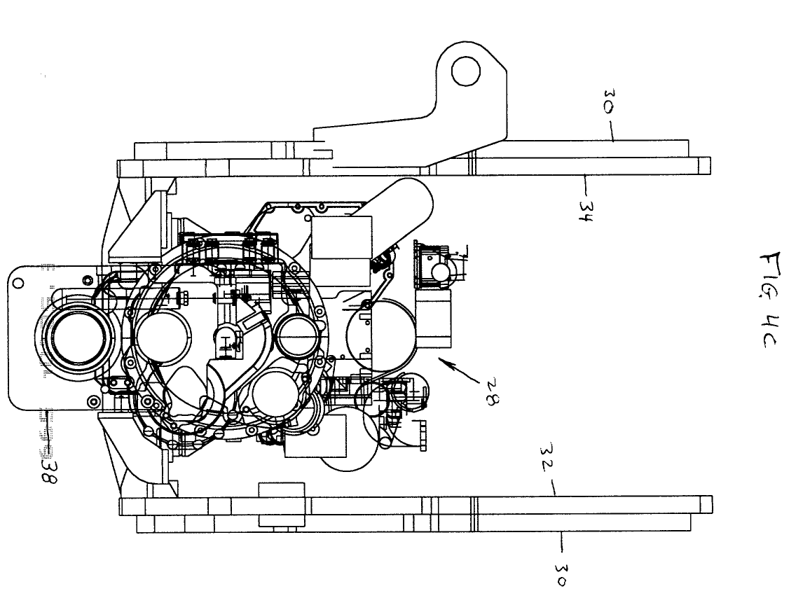

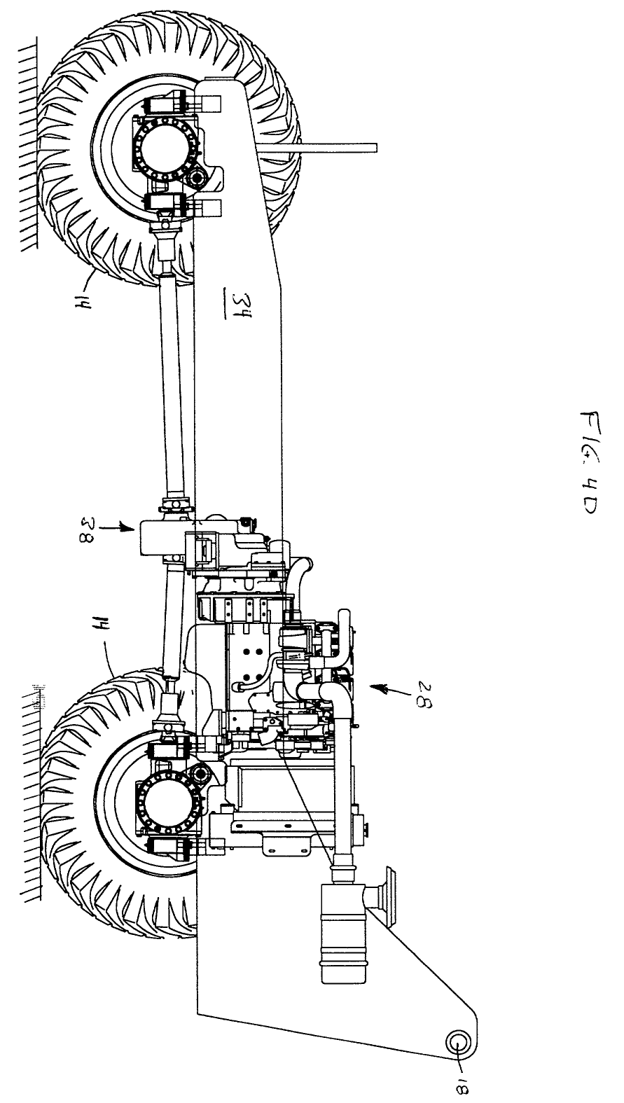

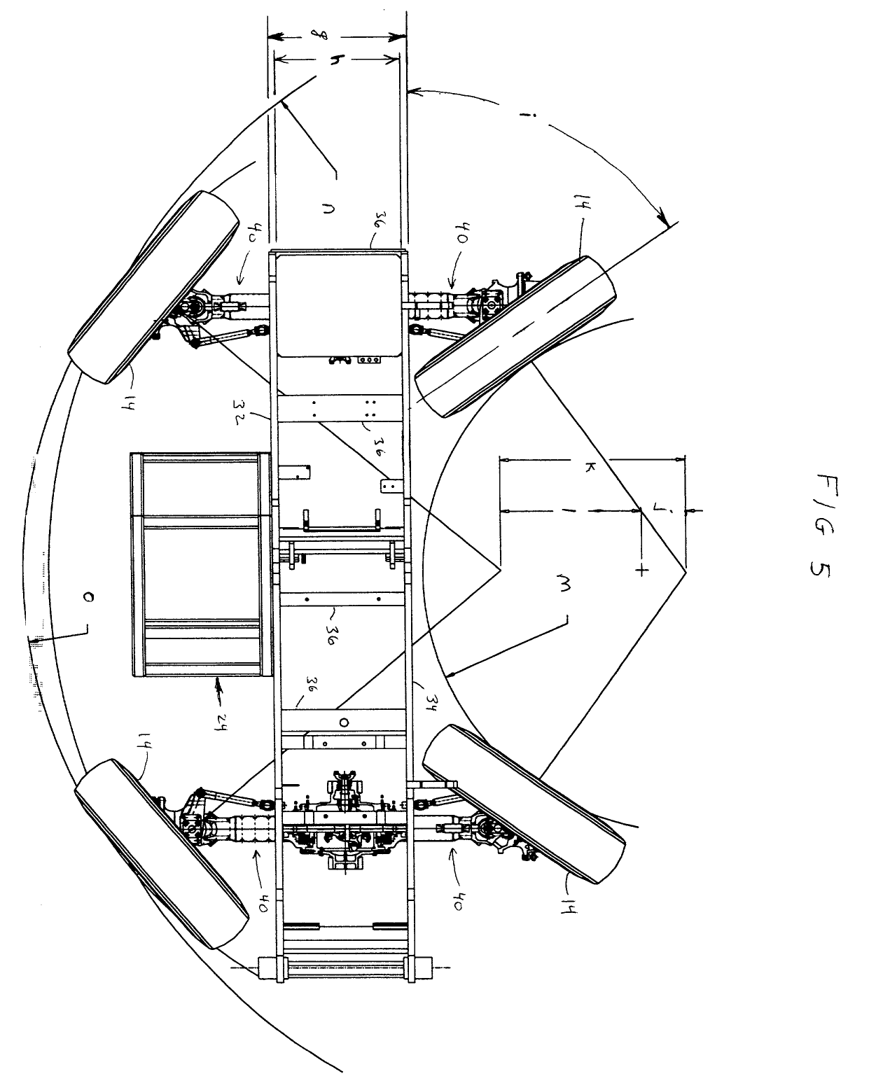

Two elevating cylinders 26 are pivotally connected between the boom 16 and the frame 12, one at each side of the boom 16. The elevating cylinders 26 are preferably hydraulically controlled wherein the hydraulics are powered by an engine 28 depicted in FIGS. 4A-4D. The hydraulics of the elevating cylinders 26 can be controlled by an operator to extend or contract the elevating cylinders 26 along the length thereof in order to pivot the boom 16 upward or downward about pivot point 18 thereby raising or lowering the boom free end 20. In one embodiment, the boom 16 comprises three rectangular shaped boom sections (depicted in FIGS. 3C and 3D) and at least one hydraulic cylinder (not depicted) to facilitate movement of each boom section, as is known in the industry. It should be noted that the boom sections might be of any cross-sectional shape or number. The boom free end 20 may therefore be extended outward from or retracted toward the pivot point 18 by the operator.

As discussed above, operator visibility is crucial to safe and efficient operation of an extensible boom forklift such as that of the present invention. To facilitate an unobstructed view of the terrain surrounding the forklift 10 from the operator station 24, the pivot point 18 connecting the boom 16 to the frame 12 is substantially elevated above the plane defined by the frame 12 by a pair of boom pivot supports 30 of the frame 12. The raised pivot point 18 thus elevates the rearward portion of the boom 16 to provide clearance thereunder without regard to the elevation of the boom free end 20.

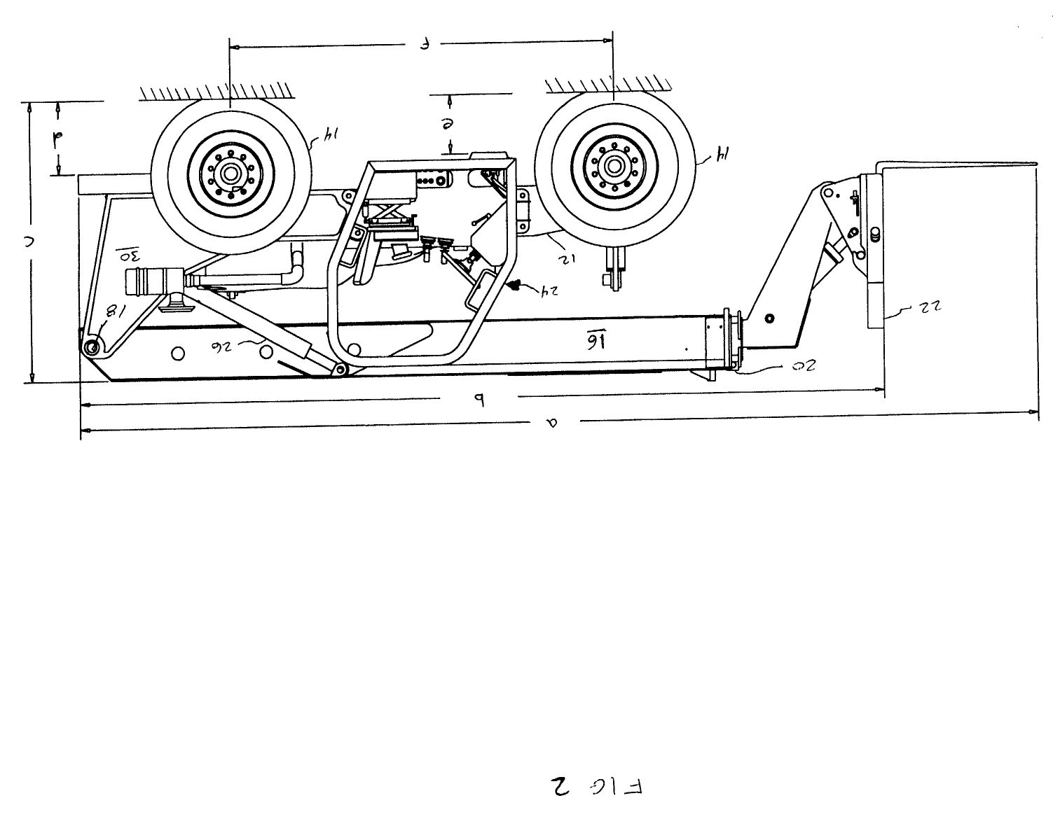

As can be seen in FIG. 2, the raised pivot point 18 provides substantial clearance under the boom 16 such that an operator has a substantially unobstructed view of the terrain behind the forklift 10 between the boom pivot supports 30. Moreover, as depicted in FIG. 2, when the boom 16 of the present invention is raised into a travel configuration, the clearance provided by the elevated pivot point 18 leaves the operator's line of sight to the terrain about the right side of the forklift 10, in addition to rearward of the forklift 10, clear of obstruction. Therefore, because the operator is inherently provided with an unobstructed view of the left and front side of the forklift 10 by the position of the operator station 24, the raised pivot point 18 assists in providing a complete spectrum of unobstructed visibility of the terrain about the forklift 10. It should be noted that this spectrum of visibility would be provided regardless of on which side of the forklift 10 the operator station 24 is positioned. The operator station 24 may, therefore, be placed on the right side of forklift 10 as may be desirable, for example, in the United Kingdom where drivers are accustomed to driving from the right side of a vehicle.

FIG. 3A depicts the boom 16 raised into an elevated position to handle an elevated load. FIG. 3B depicts the boom 16 in a lowered position such as when handling a load resting on the ground. FIG. 3C depicts the boom 16 telescopically extended in an elevated position while FIG. 3D depicts the boom 16 telescopically extended in a horizontal position to handle a load, for example, through a window frame of a building. It can be seen that the visibility of the terrain surrounding the forklift 10 is not obstructed by the boom 16 in any of the positions depicted in FIGS. 3A-3D.

The complete spectrum of unobstructed terrain visibility about the forklift 10 is further assisted by the configuration of the frame 12 of the present invention. Turning to FIG. 4A, the frame 12 comprises opposing frame side rails 32 and 34 which preferably, although not necessarily, run substantially parallel to one another along the length of the frame 12 and are connected to one another by traversing support members 36, some of which may be employed to support the engine 28 or portions of the drive train 38. As shown, the boom pivot supports 30 are fixed, one each, to the outer side of the side rails 32, 34. In the embodiment depicted in FIG. 4A, the boom pivot supports 30 extend over substantially the entire rearward outer portion of the side rails 32, 34. The strength of the frame 12 is therefore substantially bolstered at the rearward portion thereof where stresses resulting from the holding and moving of a load with the boom 16 will be most realized. The engine 28 of the present invention, as depicted in FIGS. 4A-4D, is located between the opposing frame side rails 32 and 34. The relationship between the engine 28 and the frame 12 will be described in further detail below.

As mentioned above, positioning the engine 28 centrally within the frame 12 allows the operator to see over the engine 28 and down to the terrain between the right front wheel 14 and right rear wheel 14 as well as outward to the right of the forklift 10. The central location of the engine 28 also provides the operator of the forklift 10 with an unobstructed view rearward of the forklift 10. The centrally mounted engine 28, in combination with the raised pivot point 18, thus operate together to afford the operator of the forklift 10 with the unobstructed view of the surrounding terrain and the ability to operate the forklift 10 in a safe manner. Because the operator knows when the terrain about the forklift 10 is clear of obstructions, the operator will also perform with confidence and, therefore, more quickly and efficiently.

The forklift 10, as depicted in FIG. 5, comprises front and rear turn axles 40 attached to the frame 12 and extending outward therefrom to support each of the respective four wheels 14. The turn axles 40 facilitate the ability of each wheel 14 to pivot through an angle i relative to the frame 12 as depicted in FIG. 5 to control the direction in which the forklift travels. It has been found that a wheel rotation through angle i of 55° to either side of parallel with the frame side rails 32, 34 affords an acceptable turning radius to the forklift 10. The forklift 10 of the present invention employs large diameter tires to comprise wheels 14 to allow the forklift 10 to traverse rough terrain. It has been found that employing 1300×24 tires to comprise the wheels 14 will provide sufficient ground clearance to allow the forklift 10 to traverse rough terrain such as experienced at a construction site. The 13:00×24-12PR SGG-2A tire produced by Goodyear and sold under the name “Sure Grip” has been found to be such a tire. Other tire manufacturers make similar tires that are suitable for this application.

In order to facilitate a high degree of pivot for the wheels 14 comprised of large diameter tires, the turn axles 40 must space the wheels 14 a sufficient distance from the frame 12 to prevent the tire outer diameter from contacting frame 12 at the maximum degree of wheel pivot. This distance will be referred to herein as tire clearance. For example, when comprising wheels 14 of a 1300×24 tire it is desired to provide a sufficient tire clearance between the frame 12 and the wheel 14 to achieve a 55° wheel pivot angle i. It has been found that a turn axle such as the PS6052 offered by Spicer Clark-Hurth under model numbers 060BP107-2 and 060BP107-4 will provide this 55° wheel pivot angle i and, thus, an acceptable tire clearance for 1300×24 tires. Other axle manufacturers also manufacture suitable axles.

As discussed above, it was previously thought that a trade off between the turning radius of a forklift and the overall width of that forklift was unavoidable because it was believed that the tire clearance needed for a high degree of wheel pivot could only be obtained by widening the span of the wheels 14 to space the wheels 14 from the frame 12. It has been found, however, that a tight turning radius, and therefore increased maneuverability, can be obtained, without increasing the overall width of the forklift 10, by narrowing the width of the frame 12. That is, the extra tire clearance needed between the frame 12 and the wheels 14 to provide a tight turning radius can be accommodated by narrowing the frame 12 inward from the tires 14 rather than spreading the tires 14 farther apart. In this manner the forklift 10 is provided with a tight turning radius while retaining a narrow overall width suitable for passing through narrow passageways. The embodiment of the present invention depicted in FIG. 1 has been found to be capable of providing an angle of wheel pivot i of 55° while employing 1300×24 tires and maintaining an overall width of the forklift 10, as measured from the outside of opposing tires 14, of 102.25 inches. Difficulties occur, however, in properly centrally mounting the engine 28 (in order to increase operator visibility as discussed above) into the narrowed frame 12 of the present invention. These difficulties have heretofore prevented the fork lift industry from employing such a narrow frame with a centrally mounted engine. The production of a rough terrain forklift providing a high degree of maneuverability and a complete terrain visibility from an operator station has thus been heretofore unknown.

To assist in minimizing the frame width, the present invention minimizes the width of each frame side rail 32, 34 by comprising each of a single, solid plate. The industry standard currently employs hollow tubular or box frame rails in an attempt to maximize the strength to weight ratio of the frame as is known in the industry according to basic engineering principles. A frame side rail representative of the current industry standard could, by way of example, comprise a 4×10 inch box section. By comprising the frame side rails 32, 34 of the present invention of a solid plate, the width of the frame side rails 32, 34, and therefore the overall width of the frame 12, is minimized. In one embodiment of the present invention, the frame side rails 32, 34 are each comprised of 1.5 inch thick solid steel plate. Therefore, keeping the distance between the frame side rails 32, 34 constant to accommodate the engine 28, the frame side rails 32, 34 of the present invention facilitates a forklift 10 having an overall width five inches narrower than a forklift employing industry standard frame side rails. By thus minimizing the overall width of the frame 12, the forklift 10 of the present invention is able to provide sufficient tire clearance to achieve a tight turning radius while minimizing the overall width of the forklift 10. Moreover, it has also been found that by comprising each of the frame side rails 32, 34 of a solid plate, the weight of the frame 12 is evenly distributed across the length thereof, thereby lessening the magnitude of the overturn moment experienced at the rear of the forklift 10. In one embodiment, the boom pivot supports 30 are also both comprised of the same 1.5 inch solid steel plate used to construct the frame side rails 32, 34 discussed above. In this embodiment, the thickness, and therefore the strength, of the frame 12 is doubled at the rearward portion of the frame 12. The resulting thin frame side rails 32, 34 of the present invention allow the forklift 10 to enjoy a 55° tire pivot angle i with 1300×24 tires while maintaining an overall width of the forklift 10 of 102.25 inches. Moreover, the additional weight imparted to the frame 12 by employing solid, steel plates for the frame side rails 32, 34 rather than box or tubular section, increases the stability of the forklift 10. Additionally, the solid plate frame 12 is relatively cheaper to manufacture.

As depicted in FIGS. 4A-4D, the frame side rails 32, 34 of the present invention are spaced from one another a distance only slightly greater than the width of the engine 28 positioned therebetween. In this configuration, little space is available for the necessities of an engine. Accordingly, it has been found that by rerouting the necessities such as the power train 38, hydraulic lines necessary to operate the boom 16, a radiator and cooling lines running therefrom to the engine 28, and air intake and exhaust circuits the narrow fame 12 of the present invention may be employed with the centrally mounted engine 28. The forklift 10 is therefore provided with the high maneuverability afforded by both a tight turning radius and a minimum overall size, while also providing an operator of the forklift 10 with complete visibility of the surrounding terrain.

With the forklift of the present invention thus configured, the frame 12 provides a forklift 10 with at least the following three heretofore unknown advantages: (1) it accomodates a centrally mounted engine 28 and drive train 38 to afford complete terrain visibility to the forklift operator, (2) while accommodating a high degree of rotation of the wheels 14 comprising large diameter, rough terrain tires, and (3) maintaining a narrow overall width and a low profile of the forklift 10. Specifically, in one embodiment, the centrally mounted engine 28 in the narrow frame 12 allows complete terrain visibility from a forklift 10 having a turning radius of 138 inches (as measured to the outside wheel 14) when employing 1300×24 tires, having a turn axle 40 separation f of 120 inches, an overall width (as measured from the outside of the left wheel 14 to the outside of the right wheel 14) of 102.25 inches and an overall height c of 88 inches.

While the forklift of the present invention is not to be limited to specific dimensions, the following dimensions, with reference to at least FIGS. 2 and 5, have been found to provide a forklift 10 in compliance with the above discussion:

| | |
|---|---|
| Reference No. | Dimension |

| | | |
|---|---|---|
| a | 298 9/16 | inches |
| b | 250 15/16 | inches |
| c | 88 | inches |
| d | 22 13/16 | inches |
| e | 18 9/16 | inches |
| f | 120 | inches |
| g | 31 | inches |
| h | 28 | inches |
| i | 55 | degrees |
| j | 9 31/32 | inches |
| k | 41 ⅝ | inches |
| l | 31 21/32 | inches |
| m | 59 7/16 | inch radius |
| n | 134 1/16 | inch radius |
| o | 108 9/32 | inch radius |

In addition to the above-discussed advantages afforded by the centrally mounted engine 28 of the present invention, it has also been found that the centrally mounted engine 28 provides a low and centrally located center of gravity of the forklift 10 thus increasing its stability. Additionally, centrally mounting the engine 28 affords easy transfer of power from the engine 28 to the turn axles 40. Forklifts employing side mounted engines were required to route a drive train from the side mounted engine into the center of the frame and then split the power train to both the front and rear axles. The present forklift 10 has already centrally mounted the engine 28 such that the drive train 38 may simply extend from the engine 28 forward and rearward to the turn axles 40 as depicted in FIG. 4D.

From the foregoing description, it will be apparent that the forklift of the present invention has a number of advantages, some of which have been described above and others of which are inherent therein. Also, it will be understood that modifications can be made to the forklift of the present invention without departing from the teachings herein. Accordingly the scope of the invention is limited only as necessitated by the accompanying claims.

We claim:

1. A forklift comprising:
a substantially narrow frame;
a plurality of wheels, each separately and rotatably mounted to the frame; and
an engine centrally mounted to the narrow frame, and
wherein the wheels comprise a large outer diameter to allow the forklift to traverse rough terrain.
